(19) United States
(12) Patent Application Publication
(10) Pub. No.: US 2005/0255428 A1
(43) Pub. Date: Nov. 17, 2005

(54) Dental insert and method of tooth restoration

(76) Inventor: Allan Coopersmith, Montreal (CA)

Correspondence Address: Dr. Allan Coopersmith, 5757 Decelles #520, Montreal, QC, H3S 2C3, CA

(21) Appl. No.: 11/127,120

(22) Filed: May 12, 2005

Related U.S. Application Data
(60) Provisional application No. 60/570,866, filed on May 14, 2004.

(51) Int. Cl. A61C 5/04

(52) U.S. Cl. 433/222.1; 433/226

(57) ABSTRACT

A device for creating interproximal contacts of restorations placed between posterior and anterior teeth comprising a single or plurality of dental inserts which is sized and dimensioned and can be inserted into unset restorative material and compacted so as to exert lateral forces in the interproximal areas of tooth preparations thereby creating tight anatomical and functional interproximal contacts. A method of use of said dental inserts is also described.

The present application claims the benefit of U.S. Provisional Patent Application Ser. No. 60/570,866 entitled “Dental Insert and Method of tooth Restoration” filed May 14, 2004. The contents of this application is incorporated herein by reference.

### FIELD OF INVENTION

A dental insert is described which is hard and compressible and is curved or rounded of various shapes and sizes and which can be inserted into unset restorative material and compacted so as to exert lateral forces in interproximal areas of tooth preparations for posterior and anterior restorations thereby creating tight anatomical and functional interproximal contacts. A method of use of said dental inserts is also described.

### BACKGROUND OF THE INVENTION

Amalgam restorations are dense and compactable and an operator could easily condense amalgam into a proximal cavity thereby creating a well defined and strong contact area with a proximal tooth. Composite resins in general are not nearly as dense or compactable as silver amalgam. Consequently, these resins are difficult to pack into the proximal box of a class two filling sufficiently to drive apart the tooth receiving the filling and the adjacent tooth (or teeth in the case where proximal surfaces at both sides of the tooth are being treated). Consequently, when a commonly used matrix band is removed from a class 2 filling made with composite material, a gap often remains between the filled tooth and the adjacent tooth. The gap is typically roughly as wide as the thickness of the matrix band which was used in the filling. For example, about 0.001 to 0.0015 inch wide for many types of matrix bands. These gaps are too wide to allow creation of a good proximal contact.

One recent attempt to solve the problem of open contacts in class 2 composite fillings has been to use so-called “condensable” composite resins formulated to be as much as possible like silver amalgam in their handling properties and their ability to be condensed or compacted when packed tightly into a hole or void in a tooth. However, problems still remain as resins of this type known to the inventor at this time are not dense enough or compactable enough to entirely solve the open contact problem. Therefore there is a need to have a composite resin which contains larger beads of pre-set and pre-shrunk composite resin or quartz or glass or other suitable substance, or any combination or plurality or plurality of combinations thereof, which when condensed will impart adequate compression in a proximal direction thereby creating and maintaining an adequate contact with the adjacent tooth. There is also a need for a dental insert which is shaped so as to wedge into cavity preparations of different sizes and shapes.

The contact area of restorations between adjacent teeth should be anatomical, (duplicate the structure and anatomy and position of contact areas of natural unprepared teeth) and functional (exert adequate pressure against the adjacent tooth so as to hold the intra arch position of the teeth, partially resist the passage of dental floss through the contact area, and prevent food impaction between said teeth.

Instruments are available to penetrate the unset composite resin and press against the band in a proximal direction, and the composite resin is then allowed to set so as to establish a proximal contact. The instrument is then withdrawn and the space left by the instrument is backfilled with additional composite resin. The problem with this instrument and technique is that it is difficult to place adequate pressure with the instrument against the band and often so much pressure is required that the instrument slips or breaks. Once the composite resin sets around the instrument, it is often difficult for the operator to remove the instrument, and often times the composite resin sets around the undercut of the instrument whose curved surface is usually present to help contour the oval or round curved contact area further preventing an easy removal of said instrument.

It is much easier, more efficient and safer to compress apically (towards the root) than purely laterally. The axial wall of a proximal cavity preparation is usually on an angle tapered from the gingival to the occlusal aspect of the tooth, which follows the dentino-enamel junction. Apical pressure on a round or ovoid or rounded wedge shaped insert will deflect proximally and exert a proximal force thereby establishing solid contact with the adjacent tooth. Even if the axial wall is straight, a properly sized round or ovoid shape will wedge against the internal wall and push laterally creating the proper contact area. In the event that there is no axial wall which is the case in large and deep cavity preparations, an axial wall can be created by the operator by placing a mound like core of composite resin into the center of the cavity. There is a need for a dental insert or a mixture of a dental insert and composite resin or a mixture of dental inserts and composite resin which will easily, efficiently, consistently, economically, and safely establish a contact area between adjacent teeth.

Most current composite materials are designed and marketed to restore a tooth using the same composite to seal, condense, and surface said restoration. This is especially true of the latest nano technology composite resins. The problem with today's composite resins is that no one composite can seal, condense and surface finish properly. Composites which must be hard and resistant to occlusal forces and wear are not flowable nor seal dentin well. In order to be compactable, larger inserts need to be included in the composite which cannot be used on the surface as they eject from the surface leaving voids. There is a need for a dental insert which embeds into uncured composite in the restoration or which is packaged in combination with uncured composite so that it is highly condensable thereby generating anatomic and functional contacts. A layering of these materials is therefore preferred.

Doctors sometimes employ special techniques and tools to wedge apart or otherwise force apart the adjacent teeth during the filling process so that the teeth then spring back to provide the desired post-contact following the dental procedure. That is, systems have been employed to forcefully separate adjacent teeth during the filling process, much like the separation produced by packing dental amalgam into a proximal box. For example, mechanical wedges driven in place by finger pressure between adjacent teeth at a location well below the contact area have been used. U.S. Pat. No. 5,791,898, discloses an approach in which teeth are forcefully separated and then stabilized using a light curing tip. Another known technique involves forcefully separating the teeth by use of a metal ring (by way of example a tine or by way of example a Bitine Ring™) which applies powerful forces inward between the teeth at a location just beneath where they meet. Such rings have been available from Palodent, a division of Darway, Inc. of San Mateo, Calif. and also from Garrison Dental Solutions of Spring Lake, Mich. These rings are uncomfortable, difficult to place, require a special clamp, often dislodge from the teeth or break thereby propelling said ring violently towards the throat which can cause it to be swallowed or aspirated by the patient, or ejecting said ring from the patient's mouth.

(KURER) A method of and means for tooth restoration is disclosed wherein an inclusion, in the form of a preformed body (11) utilized in the creation of a contact point with an adjacent tooth, the body, which body has a profiled knuckle-forming surface thereto, being positioned in the tooth cavity and being held in pressure contact with a matrix band while the cavity is filled with composite resin so as at least partially to embed the body therein, as the resin is cured or set, the arrangement being such that, on setting or curing of the resin, the body is maintained in position in pressure contact with the matrix band.

This insert must be forced laterally against the proximal tooth which has the following drawbacks of being non efficient, places undue stress on the patient's mouth, is prone to fracture of the insert and often requires a special instrument to engage said insert. This insert is more likely to slip while applying pressure in a lateral direction and is also more likely to harm the oral tissues than if an instrument is used to compress an insert in an apical direction. Furthermore Kurer's dental insert often extends beyond the cavo surface of the prepared tooth surface, requiring said insert to be cut or polished away after the composite resin is set. This requires an extra step and raises questions of the exposed interphase between the insert and the composite resin at the restoration's surface. All of the surfaces of Kurer's dental insert is not entirely smooth nor curved nor rounded, which can lead to internal stress and resultant fracture of the final restoration.

U.S. Pat. No. 5,505,618 to Summer discloses a tooth spacer for insertion between the proximal surfaces of teeth. The tooth spacer has a body with a thin central portion partially surrounded by or enclosed by a peripheral re-enforcing portion. Various ways of forming a tooth spacer, including chemical etching, are disclosed in the Summer patent. The reinforcing portion may range from about 0.0015 to 0.003 inch, although it may be thicker. The thin central portion preferably has a thickness ranging from 0.0001 to 0.001 inch. As a result, tooth spacers of this patent may be positioned between the interproximal surfaces between adjacent teeth while virtually eliminating any wedging of the teeth apart. The U.S. Pat. No. 5,505,618 is incorporated by reference therein in it entirety.

Dentists currently employ a more liquid and flowable composite resin to restore teeth. This flowable composite resin cannot be compressed but flows more easily into hard to reach areas and narrow openings and crevices. It also seems to wet the surface of the dentin and other composite layers better. It is not as brittle as heavily filled composite resin. It has the drawbacks however of being softer, less wear resistant, and is not compressible thereby making it unsuitable to establish proper contact with adjacent teeth. It is currently common practice to place a thin layer of flowable composite resin immediately over the cured or set bonding layer so as to better seal the cut dentin surface. There is a need for a dental insert which can be embedded and enveloped in a composite and which can then be condensed so as to push against the adjacent tooth thereby producing an anatomical and functional contact. This layer can then be covered by a highly filled hard composite resin which can resist wear and occlusal or incisal forces. As there does not appear to be presently a composite material that can fulfill the three essential qualities of being 1. flowable and sealable, 2. condensable and 3. durable, hard, and wear resistible, there is a need for a method to use layers of different composites to obtain the most desirable qualities.

Most previous inventions regarding the formation of interproximal contacts refer to contacts in posterior teeth. There is also a need for a dental insert to establish proper anatomical and functional contacts between anterior teeth.

A need nevertheless remains for improved tooth inserts as well as an improved method of use.

### SUMMARY OF THE INVENTION

It is therefore an object of an aspect the present invention to provide an improved apparatus for creating interproximal contacts when restoring posterior and anterior teeth with restorative material, a preferred embodiment being composite resin.

It is a further object of an aspect of the present invention to provide an improved method for creating interproximal contacts when restoring posterior and anterior teeth.

In one aspect, as embodied and broadly described herein, the present invention provides a device for creating interproximal contacts when restoring posterior and anterior teeth, the device comprising a curved or round or ovoid or rounded wedge like bead of material, or plurality thereof, sized and dimensioned to be packed or condensed into a proximal box of a tooth prepared to receive a composite resin restoration.

The said device can be comprised of a hard, compactable material which resists deformation, a preferred embodiment which may be composite resin which has been cured or set. The device may be comprised of quartz or glass which has been treated to bond to the composite resin matrix.

The device is shaped and sized so that it can inserted into the unset restorative material and be pushed or condensed and thereby wedged between the remaining tooth structure and the matrix band and in so doing create an anatomical and functional contact with the adjacent tooth or teeth.

The device can be premixed with composite resin so that when the composite resin is placed into the proximal box or boxes of the interproximal preparation, the insert or plurality of inserts can be compressed to create an anatomical and functional contact.

A tooth may be prepared for dental procedure via conventional methods to eliminate interproximal decay and to create an interproximal preparation. The axial wall of said preparation is customarily inclined and follows the dentin enamel junction thereby creating a slope of tooth structure diverging from the gingiva to the occlusal aspect. The dental insert is embedded into the composite resin and is compacted in an apical direction against the sloped tooth structure thereby creating resultant force and pressure to be exerted outwardly against the matrix band towards the adjacent tooth. The curved contour of the dental insert and the resultant wedging effect of the insert against the proximal tooth creates an improved anatomical and functional contact.

The dental insert is prefabricated to be of a size and dimension allowing it to be wedged between the axial wall and the matrix band and to be condensed (forced) against the proximal tooth using conventional dental condensing instruments. This packing causes axial and apical pressure on the dental insert causing it to form a well contoured composite restoration with both anatomic and functional interproximal contacts.

The present invention overcomes the deficiencies of the prior art in several respects. Because the dental insert is correctly sized to fit between the sloped axial wall and the matrix band, easy and safe and controllable apical pressure creates significant lateral pressure ensuring tight functional and anatomic contacts. Furthermore because said insert is already set and hard and pre-shrunk, the resultant restoration is stronger and harder and better than conventional composite resin restorations. The curved or round surfaces of the dental insert(s) creates a wedge like action to help create tight and anatomic and functional contacts without creating internal stresses of the set restoration which can contribute to fracture and failure.

Moreover, the dental insert(s) of the present invention are easy to handle and to place, are inexpensive, are easy to sterilize and may be easily individually packaged to retain their sterility. Finally, the insert(s) of the present invention allow for faster, more accurate and predictable and less damaging interproximal contact formation, leading to better results from the dental procedures (e.g. restoring cavities between teeth) that they are intended to facilitate.

As used in the context of the present specification, the term “dental insert” is intended to include any hard rounded or curved structure, whether round or ovoid or curved wedged—like or otherwise in shape. As non-limiting examples, the dental insert may be circular, elliptical, oval, rounded-triangular, or rounded wedge in shape when viewed from above. An ovoid or circular shape is a preferred embodiment of the present invention.

Similarly, the dental insert of the present invention is not intended to be restricted to one having any particular cross-section. Dental inserts having all types of cross-sections are believed to be within its scope.

The dental insert is sized and dimensioned to allow it to be easily packed into the proximal box of a prepared tooth. It should be understood that since each human has several different types of teeth, each being of different size, and that since the size of the same type of tooth will vary between humans, and since the decay and resultant cavities vary as well there are dental inserts of the present invention of many sizes and shapes. Indeed, it is contemplated that, in commercial use, several different sizes and shapes of dental inserts of the present invention will be sold.

It is highly preferable that the dental insert be hard and compactable. The shape of the dental insert should not be able to be altered by the force exerted thereon used to pack the dental insert into the interproximal box.

The material(s) of which the dental insert is constructed preferably is (are) one (or more) selected from the group consisting of composite resin, quartz, glass, plastic. More preferably, the material is composite resin which has similar composition and physical properties as the composite resin materials customarily used to restore teeth. For simplicity and ease of use and manufacture it is preferred that the material can be easily inserted into moulds and then set or cured so as to make said inserts hard and compactable and add strength to the final restoration.

The methods of use and other objects and features will become apparent by reference to the following description and the drawings.

### BRIEF DESCRIPTION OF THE DRAWINGS

FIG. 1 refers to the occlusal or top view of posterior teeth indicating the interproximal contacts which are areas of contact between adjacent teeth and are located facially from the tooth center.

FIG. 2. refers to the cross section of a facial view of the interproximal contacts of adjacent posterior teeth demonstrating the relationship of the contact point, interproximal caries, the dentino enamel junction, and the axial wall of the preparation. Interproximal caries is usually found just gingival to the contact area and follows the dentino-enamel junction. The axial wall of the preparation follows the dentino-enamel junction and is therefore narrowest at the gingival margin where the enamel is thinnest and widest at the occlusal where the enamel is thickest to protect the biting surfaces of the tooth.

FIG. 3 refers to the cross section of a facial view of the interproximal contacts of adjacent posterior teeth.

FIG. 4 refers to the cross section of a facial view of the interproximal contacts of adjacent anterior teeth.

FIG. 5 refers to the Incisal or top view of anterior teeth indicating the interproximal contacts which are areas of contact between adjacent teeth and are located facially from the tooth center.

FIG. 6 refers to the top or occlusal view of posterior teeth that have been prepared for class 2 or interproximal restorations indicating matrix bands and interproximal wedges which help to form the restoration and dental inserts which have been wedged into the interproximal boxes thereby creating anatomical and functional contact areas between adjacent teeth.

FIG. 7 refers to the cross section of a facial aspect of anterior teeth that have been prepared for class 3 or or class 4 interproximal restorations indicating matrix bands and interproximal wedges which help to form the restoration and contact beads which have been wedged into the interproximal preparations thereby creating anatomical and functional contact areas between adjacent teeth.

FIG. 8 refers to the cross section of a facial aspect of posterior teeth that have been prepared for interproximal restorations and demonstrates the wedging of the contact beads into the interproximal areas by wedging the dental insert in an apical direction with a plugger type instrument, thereby producing axial force which in turn produces an anatomical and functional interproximal contact area. The dental insert is partially or totally embedded in composite resin, the preferred embodiment being a flowable composite resin. The adjacent tooth demonstrates a class 2 restoration in progress indicating a cured internal flowable layer covering the dentin, a cured middle layer consisting of a dental insert embedded in flowable composite resin. The dental insert is ovoid in order to conform to a smooth curved contact area. When said dental insert is placed vertically, it will produce a longer but thinner contact area. When the same dental insert is placed horizontally, it helps form a wider but shorter contact area.

When adjacent teeth are restored with adjacent interproximal contacts, (kissing class 2's), one interproximal box is restored first, then another dental insert is wedged into the interproximal box adjacent to the interproximal surface initially restored.

FIG. 9 refers to the cross section of a facial aspect of posterior teeth that have been prepared for interproximal restorations and demonstrates the wedging of the dental inserts into the interproximal areas by wedging the dental inserts in an apical direction with a plugger type instrument, thereby producing axial force which in turn produces an anatomical and functional interproximal contact area. The dental insert is partially or totally embedded in composite resin, the preferred embodiment being a flowable composite resin. The adjacent tooth demonstrates a completed class 2 restoration indicating a cured internal flowable layer (sealing layer), covering the dentin, a cured middle layer, (condensing layer) consisting of a dental insert embedded in flowable composite resin, and a top or occlusal (surface layer) (layer consisting of hard wear resistant composite resin which can withstand occlusal forces.

FIG. 10 refers to the cross section of a facial aspect of posterior teeth that have been prepared for interproximal restorations and demonstrates the wedging of the dental inserts into the interproximal areas by wedging the dental inserts in an apical direction with a plugger type instrument, thereby producing axial force which in turn produces an anatomical and functional interproximal contact area. The dental insert is partially or totally embedded in composite resin, the preferred embodiment being a flowable composite resin. The flowable composite resin is light cured as pressure is exerted against the contact bead. The distal interproximal box demonstrates an oval dental insert in the horizontal position which is embedded in set flowable composite resin. The mesial interproximal box demonstrates a dental insert being wedged into unset flowable composite resin by a plunger type instrument.

FIG. 11. refers to the cross section of a facial aspect of posterior teeth. The tooth to be restored is badly broken down and consequently had no or an inadequate axial wall in order to use to wedge a dental insert against. This tooth has been etched, and bonded. A layer of flowable composite resin has been placed on the floor of the preparation.

FIG. 12. refers to the addition of a tapering central core of composite resin which thereby creates an adequate mesial and distal axial wall which now can be used to wedge a dental insert against thereby creating lateral forces which produces anatomical and functional contacts.

FIG. 13 refers to the insertion of a flowable composite resin into the mesial interproximal box. The flowable composite resin is not cured.

FIG. 14 refers to the insertion and wedging of a dental insert into the uncured flowable composite resin situated in the mesial box of the preparation thereby creating an anatomical and functional contact area with the mesial adjacent tooth. The flowable composite resin is light cured as pressure is exerted against the dental insert

FIG. 15. refers to the insertion and wedging of a dental insert into the uncured flowable composite resin situated in the distal box of the preparation thereby creating an anatomical and functional contact area with the distal adjacent tooth. The flowable composite resin is light cured as pressure is exerted against the dental insert.

FIG. 16. refers to the insertion of a hard wear and fracture resistant filled composite resin which can be easily polished on the outer surface of the restoration.

FIG. 17 demonstrates the resultant forces of a dental insert which is forced apically as it glides along the tapered axial wall of a class 2 preparation. The axial wall of an interproximal or class 2 preparation is normally tapered from the narrow gingival floor to the wider occlusal aspect. This taper coincides and follows closely the anatomy of the dentino enamel junction. When a rounded or ovoid or curved wedge like dental insert is pressed onto the slope of this axial wall, the resultant force will be directed laterally thereby establishing an anatomical and functional contact area. The ovoid dental insert is placed longitudinally producing a longer and narrower contact area with the adjacent tooth.

FIG. 18. The ovoid dental insert is placed horizontally producing a shorter and wider contact area wit the adjacent tooth. One size dental insert can therefore produce two different type of contact areas. This simplifies the procedure and is more cost effective.

FIG. 19. The curved wedge dental insert is inserted into the interproximal box with the narrow portion pointed apically and the wider portion facing the occlusal surface. When this curved wedge like dental insert is pressed onto the slope of this axial wall, the resultant force will be directed laterally thereby establishing an anatomical and functional contact area. The ovoid dental insert is placed longitudinally producing a longer and narrower contact area with the adjacent tooth.

FIG. 20. The curved wedge dental insert is inserted into the interproximal box with the narrow portion pointed axially and the wider portion facing the proximal surface. When this curved wedge like dental insert is pressed onto the slope of this axial wall, the resultant force will be directed laterally thereby establishing an anatomical and functional contact area. The curved wedge dental insert is placed horizontally producing a shorter and wider contact area with the adjacent tooth.

FIG. 21. The round dental insert is inserted into the interproximal box. When this round like dental insert is pressed onto the slope of this axial wall, the resultant force will be directed laterally thereby establishing an anatomical and functional contact area. This round dental insert is easy to place.

FIG. 22. refers to a plurality of round dental inserts embedded in unset composite resin, which when condensed into the proximal box, will result in an apical and lateral force thereby establishing anatomical and functional contact areas.

FIG. 23 refers to a finished composite class 2 restoration consisting of a inner sealing layer of preferably flowable or semi-flowable composite resin, a middle compactable layer of composite resin containing a plurality of dental inserts, and a hard wear and fracture resistant composite surface layer. The inner sealing layer and the middle compactable layer including the dental inserts can be combined into one layer.

### DETAILED DESCRIPTION OF THE PREFERRED EMBODIMENTS

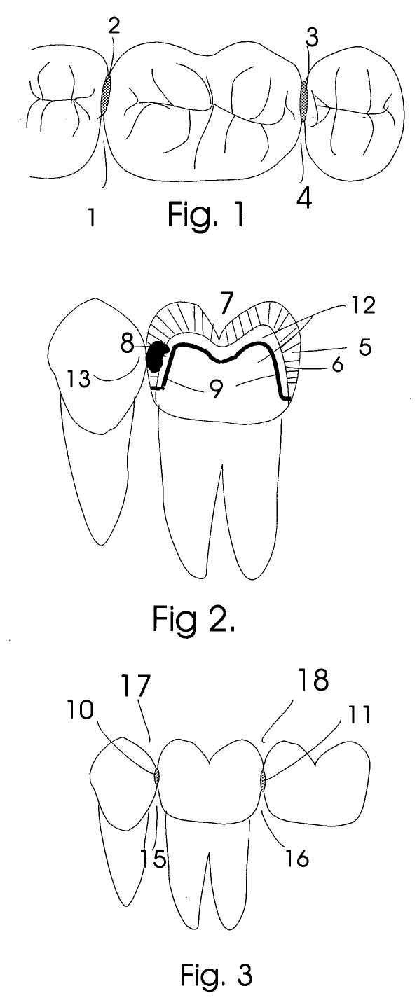

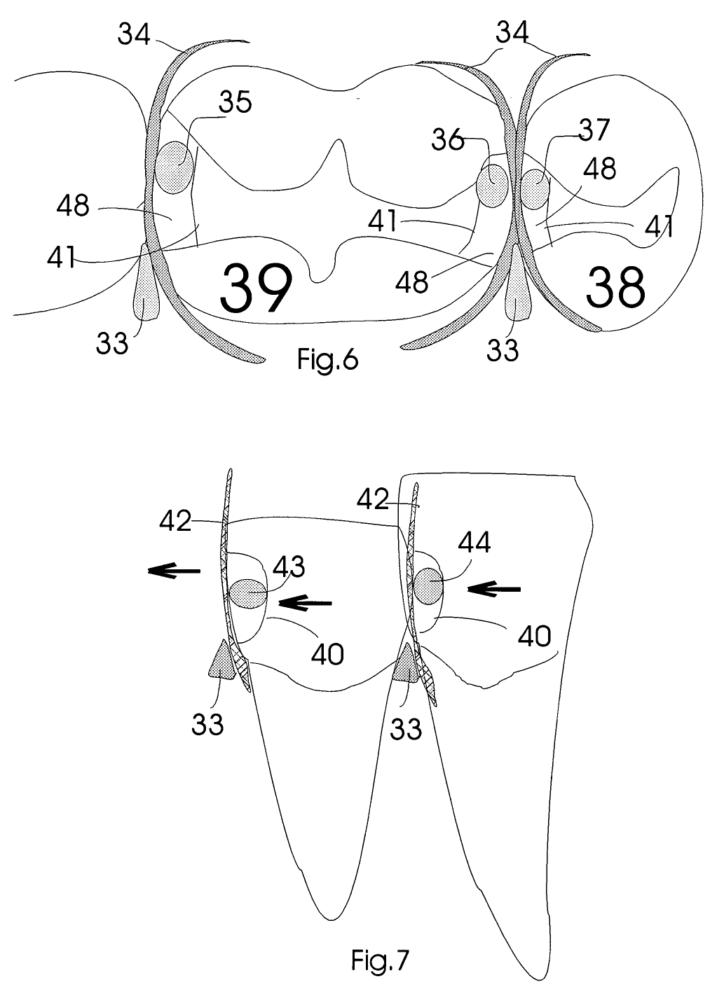

FIG. 1. demonstrates the position and contour of the interproximal contacts as viewed from the top or occlusal aspect. Note how they are located buccal to the middle of the tooth and therefore creates a more prominent lingual embrasure 1, 4, and a less prominent buccal embrasure 14. 1 refers to the distal lingual embrasure. 4 refers to the mesial lingual embrasure. 2 is the distal occlusal contact area and 3 is the mesial occlusal contact area. The preferred embodiment of the dental insert (s)(not shown but seen in FIG. 6. will be placed into the proximal box (s) to coincide with the anatomical proximal contact area of the tooth to be restored.

FIG. 2. demonstrates the anatomy and position of most interproximal decay as it relates to the anatomy of a tooth. 8 refers to caries penetrating enamel 5 and dentin 12, starting gingival to the contact area 13, extending occlusally 7 and axially towards 9. 9 refers to the slightly inclined axial wall of the preparation which ideally follows the dentino enamel junction 6.

FIG. 3 refers to the anatomy and position of the interproximal contact areas of posterior adjacent teeth. These contact areas are usually located just occlusal to the middle of the longitudinal cross section of the crown of the tooth. 10 refers to the mesial facial contact area. And 11 refers to the distal facial contact area. 15 refers to the mesial gingival embrasure and 16 refers to the distal gingival embrasure. FIGS. 1 and 3 demonstrate the structure and location of how the smooth curved surfaces of adjacent teeth contact each other and in so doing result in the anatomy of the gingival embrasures 15 & 16, and occlusal embrasures 17& 18, and facial embrasures 14, and lingual embrasures 1&4. It will be demonstrated in FIGS. 6,7,8,9, 10, 11, 12, 13, 14, 15, 16,17, 18,19, 20, 21, 22, and 23 how the smooth convex surfaces of the dental insert(s) create both anatomical and functional contact areas.

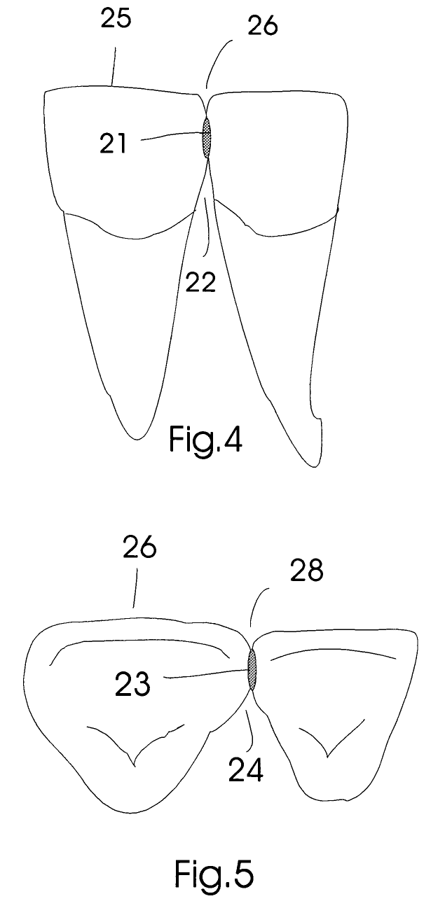

FIG. 4 refers to the anatomy and position of the interproximal contact areas of anterior adjacent teeth. These contact areas are usually located just incisal 25 to the middle of the longitudinal cross section of the crown of the tooth. 21 refers to the facial contact area. 22 refers to the resultant gingival embrasure.

FIGS. 5 and 4 demonstrate the structure and location of how the smooth curved surfaces of adjacent anterior teeth contact each other and the in so doing result in the anatomy of the gingival 22, and incisal 26, and facial 28, and lingual 24, embrasures. The interproximal contact area 23 is located facial 26 to the midline of a horizontal cross section of the tooth.

FIG. 6 demonstrates the top or occlusal view of a molar 39, and a bicuspid 38 prepared to restore interproximal decay. Ovoid dental insert(s) 35, 36, 37, have been inserted and wedged into the interproximal boxes 48, bounded by the axial wall 41, and the matrix band 34. Wedges 33, help to partially separate adjacent teeth and secure the matrix band to enable the contact beads 35,36,37, to be wedged against.

FIG. 7 demonstrates the facial view of anterior teeth prepared to restore interproximal decay. Ovoid dental insert(s) 43, 44, have been inserted and wedged into the interproximal cavity preparations, bounded by the axial wall 40, and the matrix band 42. Wedges 33, help to partially separate adjacent teeth and secure the matrix band to enable the dental insert(s) 43, 44 to be wedged against. An ovoid dental insert 43 is placed and wedged into the interproximal cavity preparation in a horizontal position to fit the wider cavity preparation. The same size and shaped ovoid dental insert is placed in a vertical direction to better fit the narrower cavity preparation. It can therefore be demonstrated that the same size and shape dental insert can be wedged effectively in cavity preparations of varying sizes and shapes making said dental inserts easier to use, more practical and more cost effective.

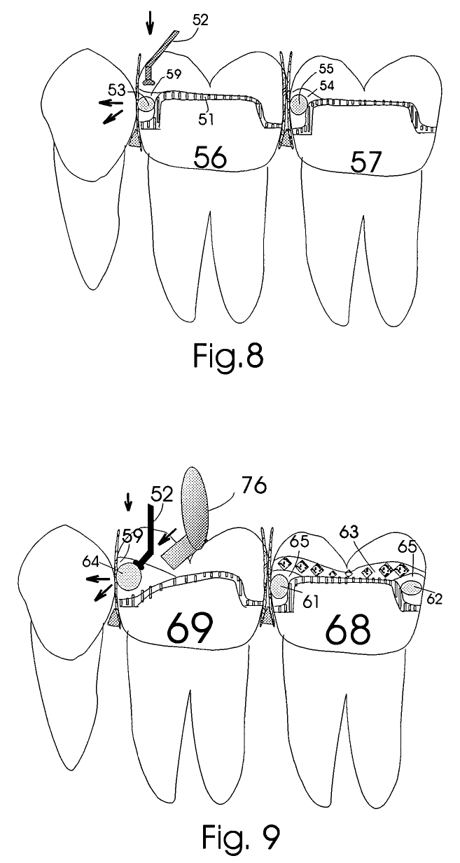

FIG. 8. Demonstrates the longitudinal cross section of posterior teeth and more specifically two adjacent molars 56 and 57 which have been prepared to receive mesial and distal class 2 restorations. Molar tooth # 56 had been etched and bonded (not shown) and it's dentin surface has been covered with a thin layer of flowable composite resin 54. A ovoid dental insert is inserted into the unset flowable composite and wedged in a horizontal position into the interproximal box by a plugger type instrument 52, so as to create a functional and anatomical contact area. The flowable composite will then be cured while pressure is exerted onto it by the plugger type instrument 52, thereby embedding said dental insert into the composite restoration. The result of this procedure is seen in tooth 57 whereby 51 refers to a cured layer of flowable composite resin; a dental insert 54 is embedded in composite resin which is in the proximal box of the preparation.

FIG. 9 demonstrates a completed composite restoration on molar 68 which shows the internal layer of a set flowable composite material 51, a larger sized ovoid dental insert 61, placed in a vertical position to accommodate a longer narrower proximal box, and a smaller ovoid dental insert 62, placed in a horizontal position to accommodate a wider shorter box. A layer of heavily filled, hard, wear resistant material 63 which can be polished well was inserted over embedded contact beads 61 and 62 and was cured and polished. The molar 69, mesial to molar 68, demonstrates how a plugger type instrument 52 can be angled laterally thereby creating lateral forces to wedge a contact bead against the adjacent tooth. When kissing class 2 preparations (adjacent teeth with adjacent proximal boxes) need to be restored, it is preferred to restore one (either mesial or distal) box first and then wedge a dental insert in the box adjacent to the one just restored—the idea being that it is preferred to wedge a dental insert against a solid surface.

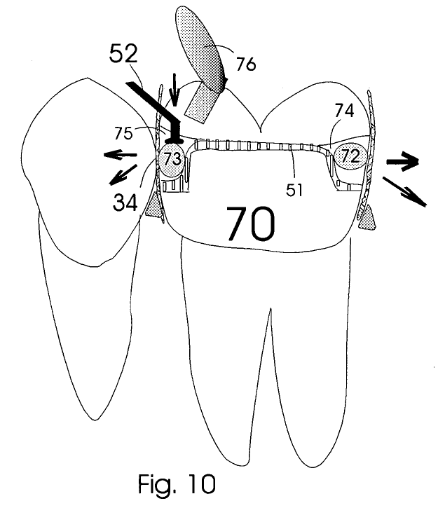

FIG. 10. demonstrates a composite restoration in progress on molar 70 which shows the internal layer of a set flowable composite material 51, an ovoid dental insert 72, placed in a horizontal position to accommodate a wider and shorter distal proximal box which is covered with a layer of composite resin which has been cured. Another ovoid dental insert 73, which is the same size but placed in a longitudinal position to accommodate a longer and narrower box is shown and it is being forced gingivally and laterally by pressure exerted on it by a plugger type instrument 52. As the plugger is wedging the dental insert against the matrix band 34, and said insert 73, is being embedded in the unset layer of composite resin 75, a light 76, is activated to set the composite resin 75.

FIG. 10 refers to the cross section of a facial aspect of posterior teeth that have been prepared for interproximal restorations and demonstrates the wedging of the dental insert(s) into the interproximal areas by wedging the dental insert(s) in an apical direction with a plugger type instrument, thereby producing axial force which in turn produces an anatomical and functional interproximal contact area. The dental insert(s) is partially or totally embedded in composite resin, the preferred embodiment being a flowable composite resin. The flowable composite resin is light cured as pressure is exerted against the dental insert. The distal interproximal box demonstrates an oval dental insert in the horizontal position which is embedded in set flowable composite resin. The mesial interproximal box demonstrates a dental insert being wedged into unset flowable composite resin by a plunger type instrument.

FIG. 11. refers to the cross section of a facial aspect of posterior teeth. The tooth to be restored is badly broken down and consequently had no or an inadequate axial wall in order to use to wedge a dental insert(s) against. This tooth has been etched, and bonded. A layer of flowable composite resin has been placed on the floor of the preparation.

FIG. 12. refers to the addition of a tapering central core of composite resin which thereby creates an adequate mesial and distal axial wall which now can be used to wedge a dental insert(s) against thereby creating lateral forces which produces anatomical and functional contacts.

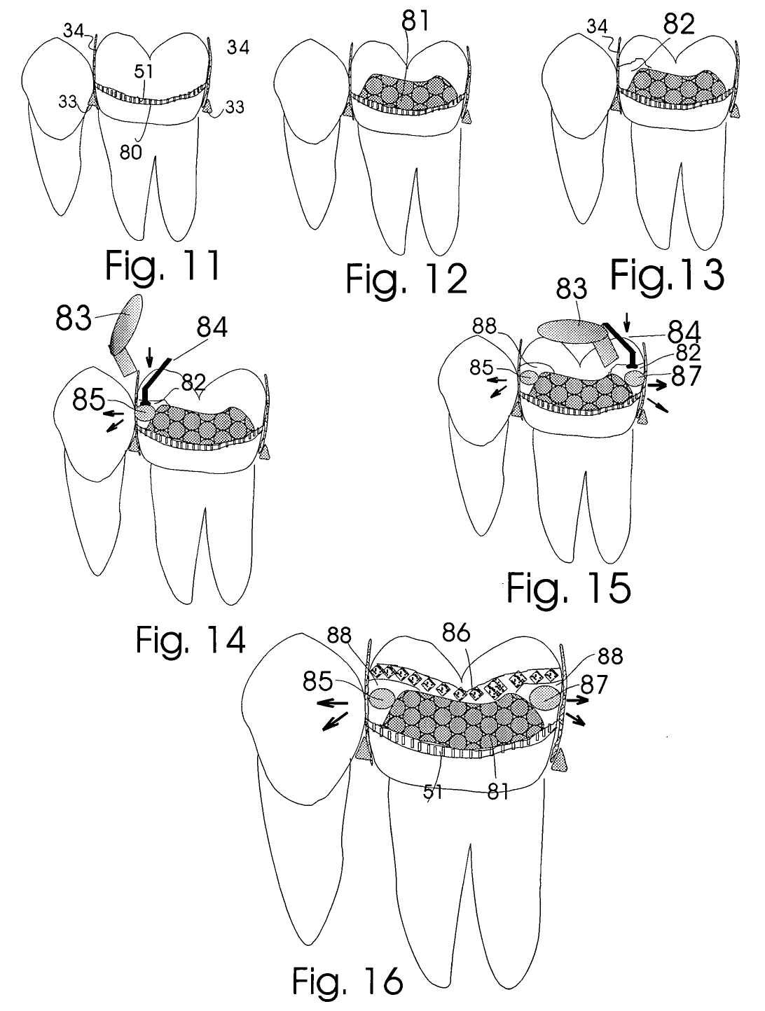

FIG. 13 refers to the insertion of a flowable composite resin into the mesial interproximal box. The flowable composite resin is not cured.

FIG. 14 refers to the insertion and wedging of a dental insert into the uncured flowable composite resin situated in the mesial box of the preparation thereby creating an anatomical and functional contact area with the mesial adjacent tooth. The flowable composite resin is light cured as pressure is exerted against the dental insert.

FIG. 15. refers to the insertion and wedging of a dental insert into the uncured flowable composite resin situated in the distal box of the preparation thereby creating an anatomical and functional contact area with the distal adjacent tooth. The flowable composite resin is light cured as pressure is exerted against the dental insert.

FIG. 16. refers to the insertion of a hard wear and fracture resistant filled composite resin on the occlusal surface of the restoration. This layer (surface layer) of composite material should be easy to and hold a polish.

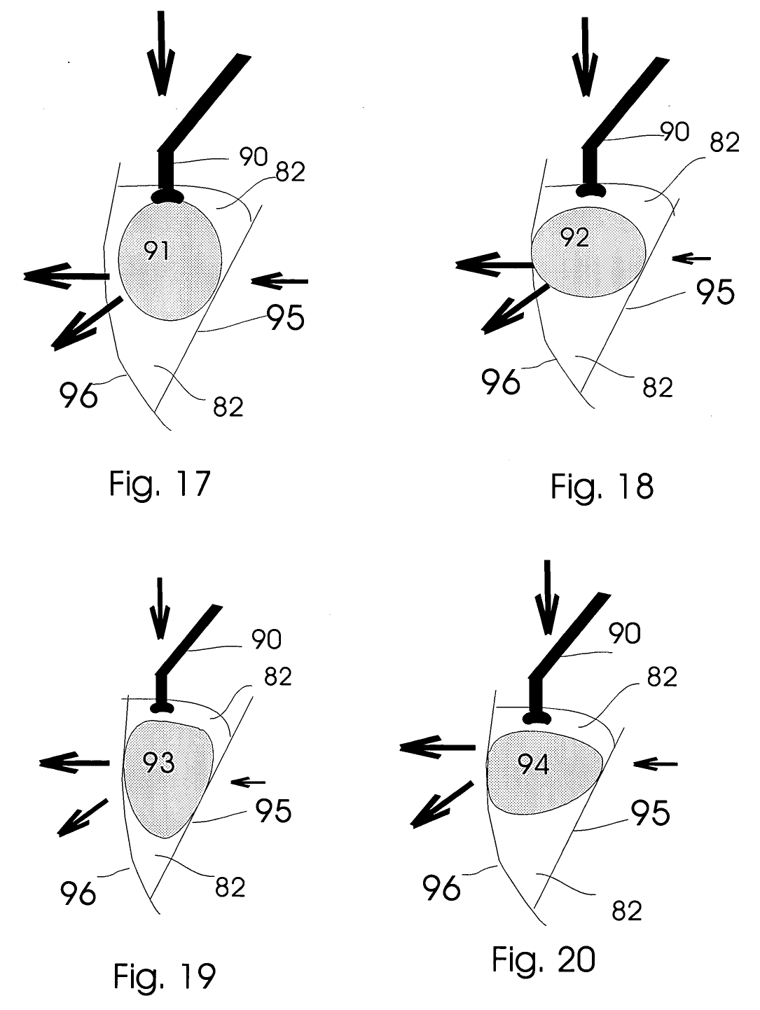

FIG. 17 demonstrates the resultant forces of a dental insert 91 which is forced apically as it glides along the tapered axial wall of a class 2 preparation. The axial wall of an interproximal or class 2 preparation is normally tapered from the narrow gingival floor to the wider occlusal aspect. This taper coincides and follows closely the anatomy of the tooth and decay as it follows the dentino-enamel junction. When a rounded or ovoid or curved wedge like dental insert is pressed onto the slope of this axial wall, the resultant force will be directed laterally thereby establishing an anatomical and functional contact area. The ovoid dental insert 91, is placed longitudinally producing a longer and narrower contact area with the adjacent tooth. This diagram illustrates how gingival pressure exerted on the ovoid curved surface of the dental insert 91 along the sloped axial wall 95, of the preparation results in lateral forces pressing up against the matrix band 96, thereby establishing a tight functional and anatomic contact area. As pressure is exerted on the dental insert, the unset composite resin 90, is light cured. The versatility of the ovoid shape of the dental insert 91, 92, can be demonstrated by changing the position of the same size of said insert 91,92 to accommodate different shapes and sizes of proximal boxes and contact areas.

FIG. 18. Illustrates an ovoid dental insert 92, lying in a horizontal position, being forced gingivally by a plugger type instrument 90, as said insert 91, is embedded in unset composite resin 82. This diagram illustrates how gingival pressure exerted on the ovoid curved surface of the dental insert 92 along the sloped axial wall 95, of the preparation results in lateral forces pressing up against the matrix band 96, thereby establishing a tight functional and anatomic contact area. As pressure is exerted on the dental insert, the unset composite resin 90, is light cured.

FIGS. 19 & 20 Illustrates an curved-wedge-like dental insert 93, lying in a vertical position, being forced gingivally by a plugger type instrument 90, as said insert 93, is embedded In unset composite resin 82. This diagram illustrates how gingival pressure exerted on the ovoid curved surface of the dental insert 93 along the sloped axial wall 95, of the preparation results in lateral forces pressing up against the matrix band 96, thereby establishing a tight functional and anatomic contact area. As pressure is exerted on the dental insert 93, the unset composite resin 90, is light cured. The versatility of the curved-wedge-like shape of the dental insert 93, 94, can be demonstrated by changing the position of the same size of said insert 93,94 to accommodate different shapes and sizes of proximal boxes and contact areas.

FIG. 20 Illustrates a curved-wedge-like dental insert 94, lying in a horizontal position, being forced gingivally by a plugger type instrument 90, as said insert 94, is embedded in unset composite resin 82. This diagram illustrates how gingival pressure exerted on the curved wedge surface of the dental insert 94 along the sloped axial wall 95, of the preparation results in lateral forces pressing up against the matrix band 96, thereby establishing a tight functional and anatomic contact area. As pressure is exerted on the dental insert, the unset composite resin 90, is light cured.

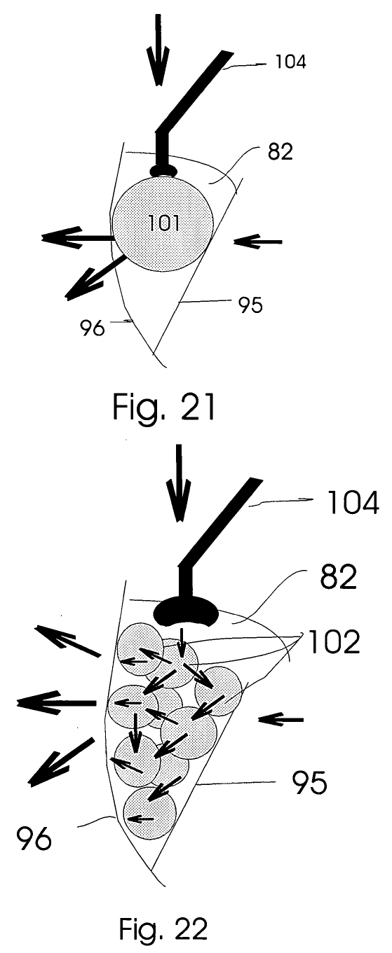

FIG. 21. Illustrates a round dental insert 101 being forced gingivally by a plugger type instrument 90, as said insert 101, is embedded In unset composite resin 82. This diagram illustrates how gingival pressure exerted on the curved wedge surface of the dental insert 101 along the sloped axial wall 95, of the preparation results in lateral forces pressing up against the matrix band 96, thereby establishing a tight functional and anatomic contact area. As pressure is exerted on the dental insert 101, the unset composite resin 90, is light cured.

FIG. 22. Illustrates a plurality of round dental inserts 102 being forced gingivally by a plugger type instrument 90, as said inserts 102, are embedded in unset composite resin 82. This diagram illustrates how gingival pressure exerted on the curved surfaces of the dental inserts 102 along the sloped axial wall 95, of the preparation results in multi directional forces acting together to exert lateral forces pressing up against the matrix band 96, thereby establishing a tight functional and anatomic contact area. As pressure is exerted on the dental inserts 102, the unset composite resin 90, is light cured.

FIG. 22. also demonstrates the insertion and subsequent compacting of a composite resin which contains a plurality of dental inserts of varying sizes (and or shapes, not shown). This composite resin would be manufactured and packaged containing these dental inserts within. The composite would be flowable or slightly flowable and the inclusion of the dental inserts would render it compactable. The curved rounded or ovoid or curved-wedge-like dental inserts

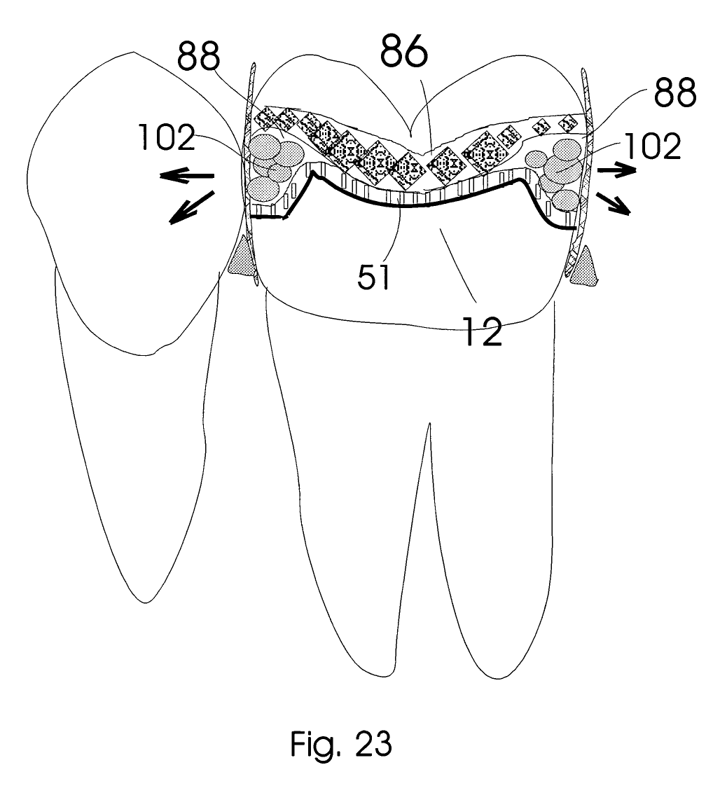

FIG. 23 Illustrates a finished restoration of an interproximal class 2 caries preparation indicating an inner sealing layer of composite resin 51, which covers the exposed dentin; an intermediate restorative condensing layer consisting of a plurality of dental inserts 102, embedded in a matrix of composite resin 88; and an outer occlusal surface layer of hard, filled, wear resistant composite resin 86, which can be easily polished. The inner layer 51 seals the bonded dentin surface and reduces post operative sensitivity. The preferred embodiment of this inner layer 51, is a flowable composite resin. The flowable composite resin 51, seeps easily into crevices and seals better, preventing voids, than the heavily filled restorations. This layer need not be compactible nor need to resist wear and occlusal forces. The intermediate layer 102 is compactable and can be forced outwardly so as to create a functional and anatomic contact area. The interproximal contact area is located at approximately the junction of the middle and occlusal 1/3 (see FIG. 3,) so the intermediate layer can be compacted to create said contact and still leave enough room to be covered by a surface layer 86, which is densely filled, hard, strong and resists wear, occlusal forces, and can be easily polished. It is possible to combine the inner 51 layer and the intermediate, compactible 102, layer into one layer if one combines a plurality of dental inserts with a flowable or semi-flowable composite.

The above description of preferred embodiments should not be interpreted in a limiting manner since other variations, modifications, and refinements are also possible with the spirit and scope of the present invention. The scope of the invention is defined in the appended claims and their equivalents.

1. I claim a dental insert material which is embedded in filling material.

2. I claim a dental insert material as described in claim 1. which is embedded in composite resin filling material.

3. I claim a dental insert material as described in claim 2. which is hard and compactable and resists deformation.

4. I claim a dental insert material as described in claim 2 which is transparent or partially transparent to light.

5. I claim a dental insert material as described in claim 2 which is comprised of numerous sizes and shapes.

6. I claim a preferred embodiment of the device claimed in 2 which is curved or round in shape.

7. I claim a preferred embodiment of the device claimed in 2 which is ovoid.

8. I claim a preferred embodiment of the device claimed in 2 which is curved-wedge-like in shape.

9. I claim a dental insert which is shaped and sized so that it can be wedged effectively in cavity preparations of varying sizes and shapes and still create an effective anatomical and functional contact.

10. I claim a dental insert material as described in claim 2. which is comprised of composite resin or any combination of composite resin, glass, or quartz.

11. I claim a dental insert material as described in claim 2. which is premixed with and contained in the unset composite resin.

12. I claim a plurality of dental inserts as described in claim 2. which is premixed with and contained in the unset composite resin.

13. I claim a dental insert material as described in claim 2. which can be efficiently compressed so as to establish an anatomically correct and effective contact with the proximal tooth.

14. I claim a dental insert material as described in claim 2. which when embedded or pre-mixed with unset composite resin forms a compressible layer of the composite resin restoration and also may be and function as the inner flowable composite resin, “sealing layer” of the restoration.

17. I claim a dental insert material as described in claim 2. which when embedded or mixed with unset composite resin forms a compressible layer of the composite resin restoration and also may be the intermediate layer between the inner flowable composite resin, “sealing layer” and the outer hard filled “surface layer” composite layer which is resistant to wear, and fracture from occlusal forces.

18. I claim a dental insert material as described in claims 2. which establishes a contact area for both posterior and anterior teeth.

19. I claim a method of:
a. restoring a tooth consisting of acid etching the internal aspect and cavo surface of the cavity preparation.
b. placing a bonding layer or a priming and bonding layer on the internal aspect and cavo surface of the cavity preparation and light curing said layer.
c. inserting into such cavity preparation a flowable or semi flowable type of restorative material to seal all exposed dentin. (Sealing Layer)
d. light curing said flowable restorative layer.
e. adding an additional layer of uncured flowable material over said cured flowable layer.
f. while said flowable restorative layer is uncured place a dental insert or plurality of dental inserts of appropriate size into a proximal box or boxes of the prepared tooth cavity allowing flowable composite to contact and partially or totally envelope said dental insert or inserts.
(The dental insert or inserts can be premixed with the flowable composite resin and the mixture comprised of the aforementioned dental insert(s) and flowable composite resin may be placed into the prepared tooth structure).
g. Press dental insert or inserts in proximal box an apical and/or lateral direction with any condenser type transparent or translucent instrument thereby exerting pressure on said dental insert(s) in an apical and proximal direction and light cure. (One proximal box is restored at a time to ensure proper contact).
h. light cure flowable restorative layer containing dental insert or inserts. (Condensing Layer)
i. cover restorative insert/flowable composite layer with posterior type composite material and light cure. (Surface Layer)
(as in any layering technique, bonding liquid placed between layers may be used to increase bonding strength. Paste type composite restorative material may be used instead of flowable composite material.)

20. I claim a method of:
a. restoring a tooth consisting of acid etching the internal aspect and cavo surface of the cavity preparation.
b. placing a bonding layer or a priming and bonding layer on the internal aspect and cavo surface of the cavity preparation and light curing said layer.
c. adding a layer of uncured flowable material over said bonding layer.
d. while said flowable restorative layer is uncured, place a dental insert or plurality of dental inserts of appropriate size into a proximal box or boxes of the prepared tooth cavity allowing flowable composite to contact and partially or totally envelope said dental insert or inserts.
(The dental insert or inserts can be premixed with the flowable composite resin and the mixture comprised of the aforementioned dental insert(s) and flowable composite resin may be placed into the prepared tooth structure).
g. Press dental insert or inserts in proximal box an apical and/or lateral direction with any condenser type transparent or translucent instrument thereby exerting pressure on said dental insert(s) in an apical and proximal direction and light cure. (One proximal box is restored at a time to ensure proper contact).
h. light cure flowable restorative layer containing dental insert or inserts. (Condensing Layer)
i. cover restorative insert/flowable composite layer with posterior type composite material and light cure. (Surface Layer)
(as in any layering technique, bonding liquid placed between layers may be used to increase bonding strength. Paste type composite restorative material may be used instead of flowable composite material.)
